(19) United States
(12) Patent Application Publication
(10) Pub. No.: US 2008/0051525 A1
(43) Pub. Date: Feb. 28, 2008

(54) Process for preparing substituted polysiloxane coatings

(76) Inventors: Mark D. Soucek, Akron, OH (US); David P. Dworak, East Hartford, CT (US)

Correspondence Address: ROETZEL AND ANDRESS, 222 SOUTH MAIN STREET, AKRON, OH, 44308, US

(21) Appl. No.: 11/823,593

(22) Filed: Jun. 28, 2007

Related U.S. Application Data
(60) Provisional application No. 60/817,196, filed on Jun. 28, 2006.

(51) Int. Cl. C08L 83/04; C08G 77/04; C08G 77/12

(52) U.S. Cl. 525/477; 528/25; 528/31

(57) ABSTRACT

The present invention relates to a process for preparing substituted polysiloxane compounds. In one embodiment, the present invention relates to processes for preparing methyl-, cyclopentyl-, and/or cyclohexyl-substituted polysiloxanes, and to the compounds prepared by such processes. In another embodiment, the present invention relates to coatings and/or films formed from the substituted polysiloxane compositions of the present invention, and to processes for preparing such coatings and/or films.

### RELATED APPLICATION DATA

This application claims priority to previously filed U.S. Provisional Application No. 60/817,196, filed on Jun. 28, 2006, entitled “Process for Preparing Substituted Polysiloxane Coatings,” which is hereby incorporated by reference in its entirety.

### FIELD OF THE INVENTION

The present invention relates to a process for preparing substituted polysiloxane compounds. In one embodiment, the present invention relates to processes for preparing methyl-, cyclopentyl-, and/or cyclohexyl-substituted polysiloxanes, and to the compounds prepared by such processes. In another embodiment, the present invention relates to coatings and/or films formed from the substituted polysiloxane compositions of the present invention, and to processes for preparing such coatings and/or films.

### BACKGROUND OF THE INVENTION

Polysiloxanes can be used in a variety of applications, including medical devices, space vehicles, and paints and coatings. Other applications of polysiloxanes include high-performance elastomers, membranes, electrical insulators, water repellants, anti-foaming agents, mold release agents, adhesives, and protective films.

Polysiloxanes and silsesquioxanes have been functionalized with various reactive groups (e.g., vinyl ethers, epoxy groups) and non-reactive groups (1-octene, substituted phenyls). The principle silane monomers have been methyl and phenyl. Prior to the present invention, cycloaliphatic silane monomers have not been reported due to difficulties in their preparation. Particularly, steric hindrances of cyclic alkenes have prevented others from successfully preparing these compounds.

In one embodiment, the present invention provides processes for preparing cycloaliphatic-substituted polysiloxanes, and as such fulfills a need within the art.

### SUMMARY OF THE INVENTION

The present invention relates to a process for preparing substituted polysiloxane compounds. In one embodiment, the present invention relates to processes for preparing methyl-, cyclopentyl-, and/or cyclohexyl-substituted polysiloxanes, and to the compounds prepared by such processes. In another embodiment, the present invention relates to coatings and/or films formed from the substituted polysiloxane compositions of the present invention, and to processes for preparing such coatings and/or films.

In one embodiment, the present invention relates to a process for preparing substituted siloxane polymers comprising the steps of: (A) providing at least one first cyclic siloxane according to the general structure shown below: 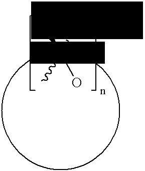
wherein R₁ and R₂ are selected independently from methyl, ethyl, propyl, butyl, cyclopentyl, and cyclohexyl and wherein n is an integer from 3 to 50; (B) providing at least one second cyclic siloxane according to the general structure shown below: 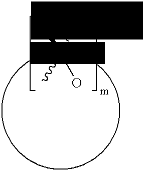
wherein R₃ and R₄ are selected independently from hydride, methyl, ethyl, propyl, butyl, cyclopentyl, and cyclohexyl, wherein at least a portion of R₃ comprises hydride, and wherein m is an integer from 3 to 50; (C) providing at least one disiloxane according to the general structure shown below: 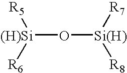
wherein R₅, R₆, R₇, and R₈ are independently selected from hydride, methyl, ethyl, propyl, butyl, cyclopentyl, and cyclohexyl; (D) combining the at least one first cyclic siloxane, the at least one second cyclic siloxane, and the at least one disiloxane with an effective amount of ion exchange resin at a temperature from about −20° C. to about 80° C., for a time sufficient to result in condensation of at least a portion of the first and second cyclic siloxane and disiloxane; and (E) recovering at least one siloxane product.

In another embodiment, the present invention relates to a process for preparing substituted siloxane polymers comprising the steps of: (a) providing at least one first cycloalkene and at least one dichlorosilane; (b) reacting the at least one first cycloalkene with the at least one dichlorosilane thereby forming at least one cycloaliphatic dichlorosilane having a general formula according to the structure below: 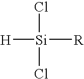
wherein R is selected from cyclopentyl and cyclohexyl; (c) polymerizing the at least one cycloaliphatic dichlorosilane thereby forming at least one cyclic oligomer of polycylcoaliphatichydrosiloxane having a general formula according to the structure below: 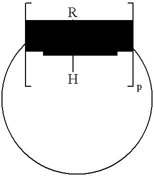
wherein p is an integer from 3 to 50; (d) reacting a first portion of the at least one cyclic oligomer of polycylcoaliphatichydrosiloxane from Step (c) with at least one second cycloalkene thereby forming at least one cyclic oligomer of polydicycloaliphaticsiloxane having a general formula according to the structure below: 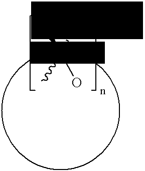
wherein the reaction is carried out in the presence of an effective amount of at least one catalyst, and wherein R₁ and R₂ are independently selected from cyclopentyl and cyclohexyl; (e) reacting a second portion of the at least one cyclic oligomer of polycylcoaliphatichydrosiloxane from Step (c) with the at least one cyclic oligomer of polydicycloaliphaticsiloxane from Step (d) thereby forming at least one copolymer thereof; and (f) recovering the at least one copolymer of Step (e).

In still another embodiment, the present invention relates to a process for preparing substituted siloxane polymers comprising the steps of: (i) providing at least one first cyclic siloxane according to the general structure shown below: 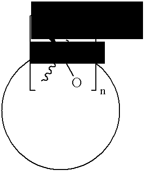
wherein R₁ and R₂ are methyl and wherein n is an integer from 3 to 50; (ii) providing at least one second cyclic siloxane according to the general structure shown below: 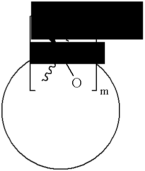
wherein R₃ and R₄ are selected independently from hydride and methyl, wherein at least a portion of R₃ and R₄ comprise hydride, and wherein m is an integer from 3 to 50; (iii) providing at least one disiloxane according to the general structure shown below: 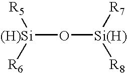
wherein R₅, R₆, R₇, and R₈ are independently selected from hydride, methyl, ethyl, propyl, butyl, cyclopentyl, and cyclohexyl; (iv) combining the at least one first cyclic siloxane, the at least one second cyclic siloxane, and the at least one disiloxane with an effective amount of ion exchange resin at a temperature from about −20° C. to about 80° C., for a time sufficient to result in condensation of at least a portion of the first and second cyclic siloxane and disiloxane; and (v) recovering at least one siloxane product.

### BRIEF DESCRIPTION OF THE DRAWINGS

FIG. 1 is a synthesis diagram showing cycloaliphatic epoxide/alkoxy silane functionalized Poly(dimethylsiloxane-co-methylhydrosiloxane);

FIG. 2 is a diagram showing a synthesis of cycloaliphatic epoxide/alkoxy silane functionalized poly(dicycloaliphaticsiloxane-co-cycloaliphatichydrosiloxane);

FIG. 3 is a FT-IR spectrum of compound 1 (i.e., poly(dimethylsiloxane-co-methylhydrosiloxane), hydride terminated);

FIG. 4 is a NMR spectrum of compound 1 (i.e., poly(dimethylsiloxane-co-methylhydrosiloxane), hydride terminated);

FIG. 5 is a silicon NMR spectrum of poly(dimethylsiloxane-co-methylhydrosiloxane), hydride terminated;

FIG. 6 is an FT-IR spectrum of cycloaliphatic epoxide/alkoxy silane functionalization of poly(dimethylsiloxane-co-methylhydrosiloxane), hydride terminated;

FIG. 7 is a proton NMR spectrum of cycloaliphatic epoxide/alkoxy silane functionalization of poly(dimethylsiloxane-co-methylhydrosiloxane), hydride terminated;

FIG. 8(a) is an FT-IR spectrum of cyclopentyldichlorosilane;

FIG. 8(b) is an FT-IR spectrum of cyclohexyldichlorosilane;

FIG. 9(a) is a proton NMR spectrum of cyclopentyldichlorosilane;

FIG. 9(b) is a NMR spectrum of cyclohexyldichlorosilane;

FIG. 10 is a silicon NMR spectrum of unpurified dicyclopentyldichlorosilane product;

FIG. 11(a) is a silicon NMR spectrum of distilled cyclopentyldichlorosilane;

FIG. 11(b) is a silicon NMR spectrum of distilled cyclohexyldichlorosilane;

FIG. 12(a) is a mass spectrum of cyclopentyldichlorosilane;

FIG. 12(b) is a mass spectrum of cyclohexyldichlorosilane;

FIG. 13(a) is an FT-IR spectrum of cyclic oligomers of polycyclopentyl-hydrosiloxane;

FIG. 13(b) is an FT-IR spectrum of cyclic oligomers of polycyclohexyl-hydrosiloxane;

FIG. 14(a) is a proton NMR spectrum of cyclic oligomers of polycyclopentyl-hydrosiloxane;

FIG. 14(b) is a proton NMR spectrum of cyclic oligomers of polycyclohexyl-hydrosiloxane;

FIG. 15(a) is a silicon NMR spectrum of cyclic oligomers of polycyclopentyl-hydrosiloxane;

FIG. 15(b) is a silicon NMR spectrum of cyclic oligomers of polycyclohexyl-hydrosiloxane;

FIG. 16(a) is a proton NMR spectrum of cyclic oligomers of polydicyclopentyl-siloxane;

FIG. 16(b) is a proton NMR spectrum of cyclic oligomers of polydicyclohexyl-siloxane;

FIG. 17 is an exotherm obtained during cationic polymerization of compound 1 at 25° C. 15 seconds; and

FIG. 18 is an overlay of three DSC curves showing the T_{g} of a cured coating with 3% photo-initiator.

### DETAILED DESCRIPTION OF THE INVENTION

The present invention relates to a process for preparing substituted polysiloxane compounds. In one embodiment, the present invention relates to processes for preparing methyl-, cyclopentyl-, and/or cyclohexyl-substituted polysiloxanes, and to the compounds prepared by such processes. In another embodiment, the present invention relates to coatings and/or films formed from the substituted polysiloxane compositions of the present invention, and to processes for preparing such coatings and/or films.

As used herein, the term “M”, when used as a descriptor for silicone subunits, includes monoxides of silicon having the general formula R₃SiO. The R-groups can vary independently among all organic and inorganic moieties including, without limitation, hydride, methyl, ethyl, propyl, butyl, pentyl, hexyl, and any regioisomers thereof including cyclic isomers such as cyclopentyl and/or cyclohexyl. Similarly, the terms “D”, “T” and “Q”, when used as descriptors of silicone subunits, includes dioxides, trioxides, and tetra-oxides of silicon respectively. Furthermore, D has the general formula R₂SiO₂, T has the general formula RSiO₃, and Q has the general formula SiO₄. The R groups of silicone units D, T, and Q are defined the same as that of unit M. Furthermore, D, T, and Q units can comprise cyclic siloxane species, wherein the cyclic backbone comprises Si—O bonds.

In one embodiment, the present invention relates to the formation of siloxanes from a combination of at least one first cyclic siloxane according to the general structure shown below: 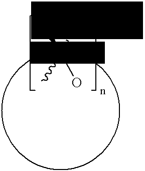
wherein R₁ and R₂ are selected independently from methyl, ethyl, propyl, butyl, cyclopentyl, and cyclohexyl and wherein n is an integer from 3 to 50; at least one second cyclic siloxane according to the general structure shown below: 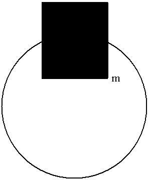
wherein R₃ and R₄ are selected independently from hydride, methyl, ethyl, propyl, butyl, cyclopentyl, and cyclohexyl, wherein at least a portion of R₃ comprises hydride and wherein m is an integer from 3 to 50, and at least one disiloxane according to the general structure shown below: 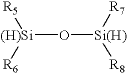
wherein R₅, R₆, R₇, and R₈ are independently selected from hydride, methyl, ethyl, propyl, butyl, cyclopentyl, and cyclohexyl.

In another embodiment, the present invention relates to a process for preparing substituted siloxane polymers from a combination of at least one first cycloalkene and at least one dichlorosilane where such a combination yields, under a proper set of reaction conditions, at least one cycloaliphatic dichlorosilane having a general formula according to the structure below: 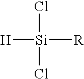
wherein R is selected from cyclopentyl and cyclohexyl. In this embodiment, the at least one cycloaliphatic dichlorosilane is subjected to polymerization to yield at least one cyclic oligomer of polycylcoaliphatichydrosiloxane having a general formula according to the structure below: 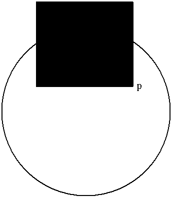
wherein p is an integer from 3 to 50. This product is then split into two portions (e.g., in halves) with the first portion being reacted with at least one second cycloalkene according to the formula above to yield at least one cyclic oligomer of polydicycloaliphaticsiloxane having a general formula according to the structure below: 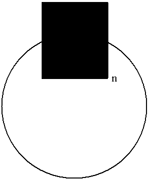
wherein R₁ and R₂ are independently selected from cyclopentyl and cyclohexyl. This reaction is, in one embodiment, carried out in the presence of an effective amount of at least one catalyst. The second portion of the at least one cyclic oligomer of polycylcoaliphatichydrosiloxane from above is then reacted with the at least one cyclic oligomer of polydicycloaliphaticsiloxane to yield at least one copolymer product.

In another embodiment, the present invention relates to a synthetic scheme for preparing cationically polymerizable methyl, cyclopentyl, and cyclohexyl substituted polysiloxanes. In some embodiments, the desired cycloalkene and dichlorosilane are reacted at pressures of about 250 psi, and temperatures of about 120° C., thereby yielding a desired cycloaliphatic dichlorosilane. In still other embodiments the cycloalkene and dichlorosilane can be reacted at gauge pressures from about zero to about 1000 psi, or from about 100 to about 500 psi, or even from about 200 to 300 psi. Furthermore, in some embodiments the cycloalkene and dichlorosilane can be reacted at temperatures from about −20° C. to about 150° C., or from about 0° C to about 140° C., or from about 50° C. to about 130° C., or even from about 100° C. to about 125° C. Here, as elsewhere in the specification and claims, individual range limits may be combined.

Furthermore, in these and other embodiments the chlorosilane monomers oligomerize thereby producing cyclic oligomers having low molecular weights that are, on average, around 2,000 grams/mole. Polysiloxanes can then be produced through acid catalyzed ring opening polymerization of such cyclic oligomers. This process can yield high molecular weight polysiloxanes. For example, polysiloxanes having molecular weights of about 42,000 grams/mole can be produced according to this and other embodiments of the present invention. In some embodiments the polysiloxanes can be further functionalized with cycloaliphatic epoxy and alkoxy silane groups through hydrosilation.

Monomers, oligomers, and polymers can be characterized by ¹H and ²⁹Si NMR, FT-IR, and electrospray ionization mass spectroscopy (ESI-MS). Photo-induced curing kinetics and activation energies can be evaluated using photo-differential scanning calorimetry (PDSC). Differential scanning calorimetry can be used to observe physical changes in the films of the present invention that are brought about by varying the pendant groups. In general, cycloaliphatic substituents raise the glass transition temperature (T_{g}) and affect the curing kinetics relative to the methyl substituted polysiloxane. In some methyl-substituted embodiments the activation energies are about 144.8±8.1 kJ/mol. In some cyclopentyl- and cyclohexyl-substituted embodiments the activation energies are about 111.0±9.2, and 125.7±8.5 kJ/mol respectively.

In some embodiments chlorosilanes can be used as building blocks for making silicones and polysiloxanes of the present invention. Chlorosilanes can be used in a variety of embodiments, in part, because they are amenable to hydrosilation reactions where a Si—H compound is added to a multiple bond, such as an alkene or alkyne. In many embodiments, platinum complexes can be used as hydrosilation catalysts due to their activity at relatively low concentrations. An example of such a platinum catalyst is chloroplatinic acid (Speier's catalyst), which is reduced to a platinum (0) species in the presence of silanes and/or siloxanes. During such reactions an induction period is sometimes observed. The induction period can be reduced or eliminated by using a platinum complex such as Karstedt's catalyst. Examples of other metal-based catalysts that can be used include the rhodium-based Wilkinson's catalyst. As will be appreciated by one of ordinary skill in the art, a wide variety of catalysts are expected to perform adequately, and thus are within the scope of the present invention.

Embodiments that involve synthesis of linear siloxane polymers can be divided into two general classifications according to the pathway in which the polymer chain is formed: (1) polymerization of difunctional silanes; and (2) ring-opening polymerization of cyclic oligosiloxanes. Hydrolytic polymerization involves the polymerization of halosilanes (e.g., chlorosilanes) through the incorporation of water. Furthermore, this type of polymerization can be used in embodiments directed to synthesizing both linear siloxane polymers and/or cyclic siloxane oligomers. Embodiments for synthesizing cyclic siloxane oligomers can also be used for making substrates used in ring-opening polymerization embodiments.

Polysiloxane chains can be formed by either, or both, of the following two polymerization embodiments: homofunctional polymerization and/or heterofunctional polymerization. Homofunctional polymerization includes reacting one or more difunctional silanes such as silanediols or dichlorosilanes. Heterofunctional polymerization includes reacting one or more silanols with another functional group. In some embodiments a heterofunctional process can be used for a hydrolytic polymerization step. In such embodiments hydrolysis and polymerization generally occur more or less simultaneously.

Embodiments involving ring-opening polymerization generally enable greater control over molecular weight, thus it is often advantageous for preparing high polymers. Such embodiments can include either anionic or cationic routes, and can be either thermodynamically or kinetically controlled. In thermodynamically driven embodiments the siloxane bonds are substantially equivalent in number and in kind both in a chain and in a ring. Thus, the net energy change is very small. Accordingly, such reactions are driven by an increase in entropy arising from the siloxane segments' increased degrees of freedom. The increase in degrees of freedom stems from conversion from cyclic to linear structures. In some embodiments, the molecular weight of cyclosiloxane polymerization equilibrium products is controlled by incorporating an end-group that ensures the closure of the chain with a neutral and/or non-reactive group.

Some embodiments include preparing poly(dimethylsiloxane-co-methylhydrosiloxane) (1) functionalized with cycloaliphatic epoxides and/or alkoxy silanes. Other embodiments include synthesizing and/or functionalizing poly(dicyclopentylsiloxane-co-cyclopentylhydrosiloxane), hydride terminated (2) and poly(dicyclohexylsiloxane-co-cyclohexylhydrosiloxane), hydride terminated (3). Embodiments for preparing cycloaliphatic substituted compounds differ from that of methyl substituted in that the cyclic species needs to be synthesized by hydrolytic polymerization of cycloaliphatic substituted silanes.

Monomers for use in connection with the present invention can be characterized using ¹H NMR, ²⁹Si NMR, FT-IR, and mass spectroscopy. According to some embodiments, homopolymers can be prepared from the monomers, oligomers, and polysiloxanes.

The following materials are used in some of the examples and embodiments set forth herein. Octamethylcyclotetrasiloxane, 1,3,5,7-tetramethylcyclotetrasiloxane, 1,1,3,3-tetramethyldisiloxane, dichlorosilane, and vinyl triethoxysilane can be purchased from Gelest, Inc. and used as supplied. Wilkinson's catalyst (chlorotris(triphenylphosphine)rhodium(l), 99.99%), Karstedt's catalyst (platinum(0)-1,3-divinyl-1,1,3,3-tetramethyldisiloxane complex, 3% w/w solution in xylenes), cyclopentene, cyclohexene, Amberlyst 15 ion-exchange resin, and 4-vinyl-1-cyclohexene 1,2-epoxide can be purchased from Aldrich and used as supplied. Toluene, supplied by Aldrich Chemical Co., can be distilled in order to eliminate any impurities. Irgacure 250 is supplied by Ciba Specialty Chemicals and can be used as received. Air sensitive materials are transferred and weighed in a dry box under argon.

The following instruments are used in some of the examples and embodiments set forth herein. Proton NMR spectra can be obtained from a Gemini-300 spectrometer (Varian), and silicon NMR spectra can be obtained on a Gemini-400 spectrometer (Varian). All NMR samples are prepared in CDCl₃ and recorded at 20° C. Chemical shifts are shown relative to a TMS internal standard. FT-IR spectra are obtained on a Mattson Genesis Series FT-IR and a Waters system is used for GPC analysis. Mass spectroscopy is performed on a Saturn 2200 (Varian) in EI mode with an ion trap read out.

The Si—H bond is polarized depending to some degree on the substituents of the silicon. The reactivity of the Si—H bond makes it possible to analyze this group with qualitative or quantitative chemical tests. The Si—H is titrated via reduction of a mercury(II) salt according to the reaction set forth in Equation 1.
—Si—H+2HgCl₂—Si—Cl+Hg₂Cl₂+HCl (1)
The HCl byproduct is then titrated against a base to determine the % Si—H in the sample.

More specifically, the Si—H determination can be carried out as follows. A mercuric chloride solution (about 4% w/v in 1:1 chloroform-methanol) is pipetted (about 20 mL) into an Erlenmeyer flask. The sample to be titrated is added and agitated before adding a calcium chloride solution (about 15 mL, saturated solution in methanol). Phenolphthalein indicator is added (about 15 drops) after about 5 to 6 minutes, and the solution is titrated with 0.1 N alcoholic potassium hydroxide. Controls are titrated in the same manner before and after the analysis. The calculation for % Si—H is shown in equation 2.
% H═[(V₁−V₂)](N_{KOH})(1.008/2000)(100)/sample wt (g) (2)
In reference to Equation 2, V, is the endpoint, V₂ is the averaged blanks, and N is the normality of the basic titrant.

Some embodiments include a photoinitiation step. This step can be performed in a variety of acceptable ways. In one example, a 2 to 3 mg sample (polymer and 3% photoinitiator w/w) is placed in an uncovered, hermetic, aluminum DSC pan. An empty pan is used as a reference. The chamber of the DSC is purged with nitrogen before the polymerization and purging continues throughout the reaction. The samples are photo-cured with UV light (150 mW/cm²) for any of a variety of exposure times (1, 5, and 15 seconds) and temperatures (−10° C., 25° C., and 60° C.). The heat flux as a function of reaction time can be monitored under isothermal conditions, and the rate of polymerization can be calculated. The heat of reaction (ΔH_{R}) for the epoxy group is 23.13 Kcal/mol.

The rate of propagation (Rₚ) is directly proportional to the rate at which heat is released from the reaction. As a result, the height of the DSC exotherm can be used to quantify the rate of polymerization. An applicable rate formula for the photo-polymerization is set forth in equation 3.
Rₚ=((Q/s).M)/(n.ΔH_{R}.m) (3)
With reference to Equation 3, Q/s is the heat flow per second released during the reaction, and is in units of Joules per second. The variable M is the molar mass of the reacting species, n is the average number of epoxy groups per polymer chain, and m is the mass of the sample.

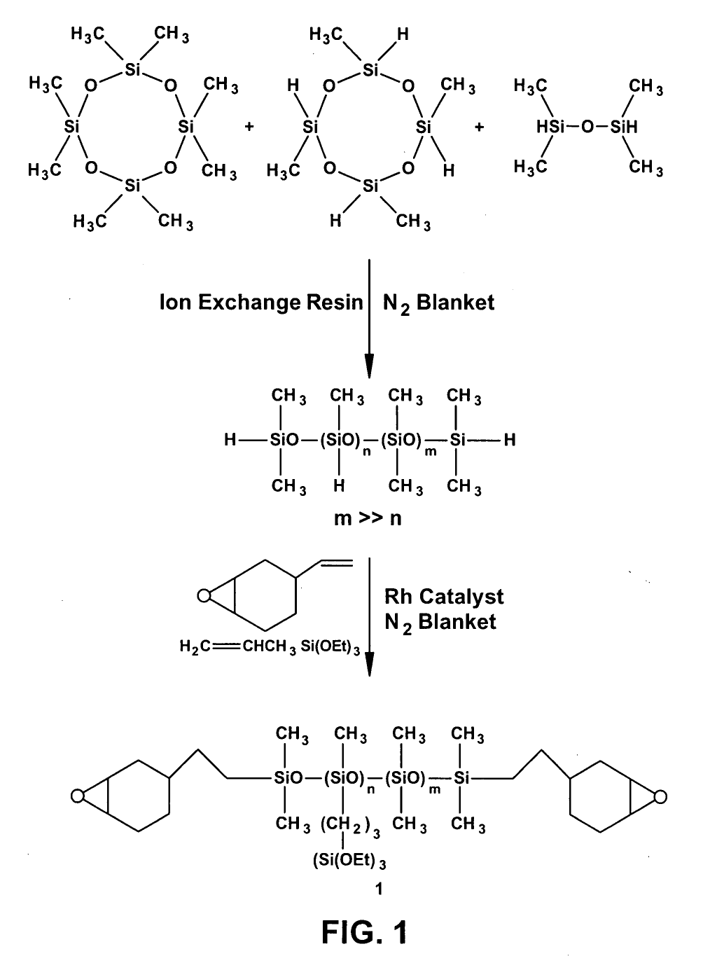

A synthesis diagram showing the functionalization of poly(dimethylsiloxane-co-methylhydrosiloxane), hydride terminated is set forth in FIG. 1. The pendant alkoxy silane aids in miscibility during formulation and provides a site for interaction with the metal/silicon-oxo-cluster, while the cycloaliphatic epoxide provides a cross-linking site for cationic UV-induced cure. In some embodiments the overall structure of 1 is a block copolymer comprising mostly ‘D’ units (R—Si—R) and the desired functionalities.

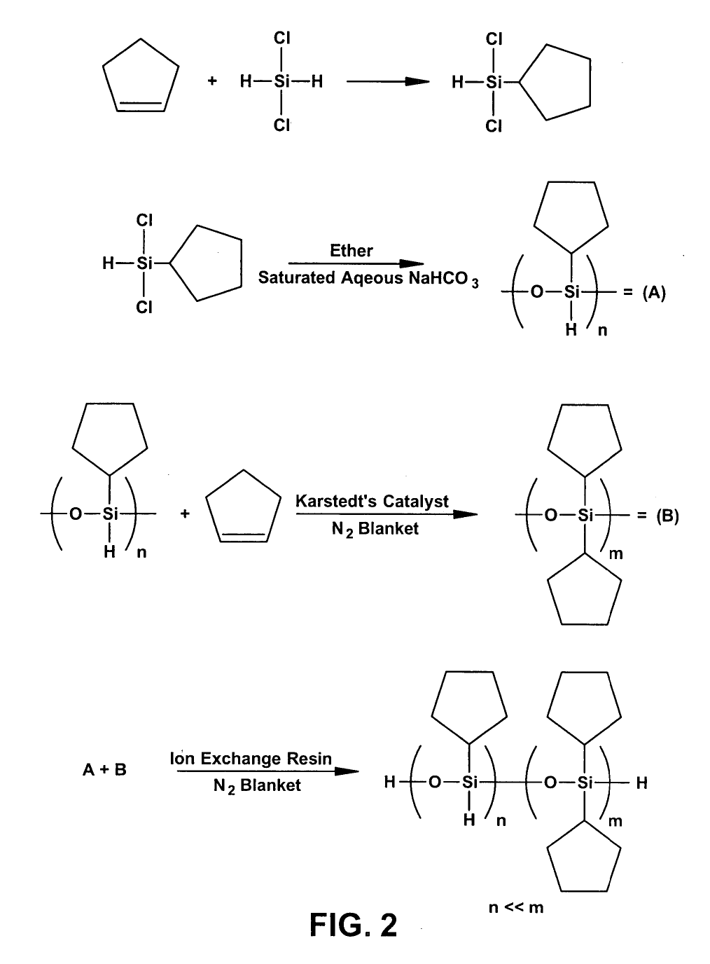

A diagram showing the synthesis of compound 2 is presented in FIG. 2. Functionalization of compounds 2 and 3 is performed in a similar manner as that of compound 1. The cycloaliphatic substitution along the polysiloxane backbone is selected so as to raise the glass transition (T_{g}) of the polysiloxane, while not contributing to yellowing caused by UV absorption.

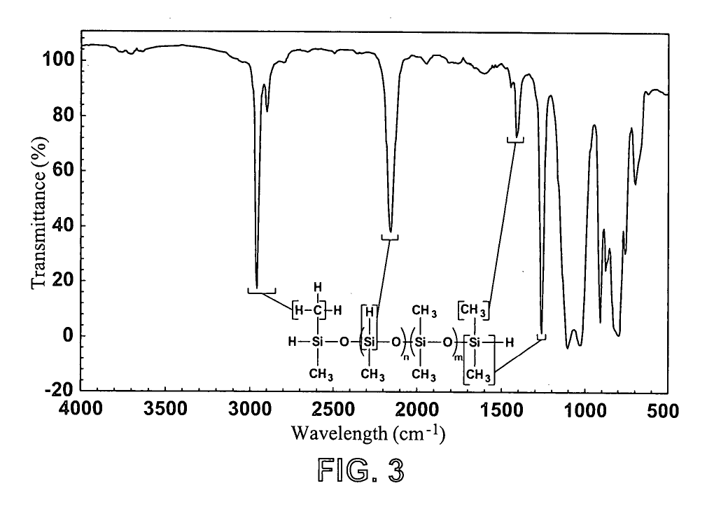

The synthesis of compound 1 can be verified by FT-IR (see example spectrum in FIG. 3). A strong peak at about 2160 cm⁻¹ indicates that the Si—H functionality is present. Peaks at about 1090 cm⁻¹ and 1110 cm⁻¹ indicate high molecular weight polysiloxanes. One or more strong and broad (e.g., spanning about 50 to 100 cm⁻¹ across) peaks in the region around 1000 cm⁻¹ suggests the presence of cyclic species. The presence of two bands in this region is strong evidence of high molecular weight species. However, cyclic species higher than 50 units long can show similar peaks thereby presenting misleading information. Therefore, GPC can be used to confirm that no cyclic species are present. When no cyclic species are present the GPC chromatogram shows a typical bell curve for high molecular weight polymer. But, when cyclic species are present the main peak is usually preceded by two additional peaks. Analyzing the reaction products for silicone hydride bonds should show about 15.3±0.8% Si—H.

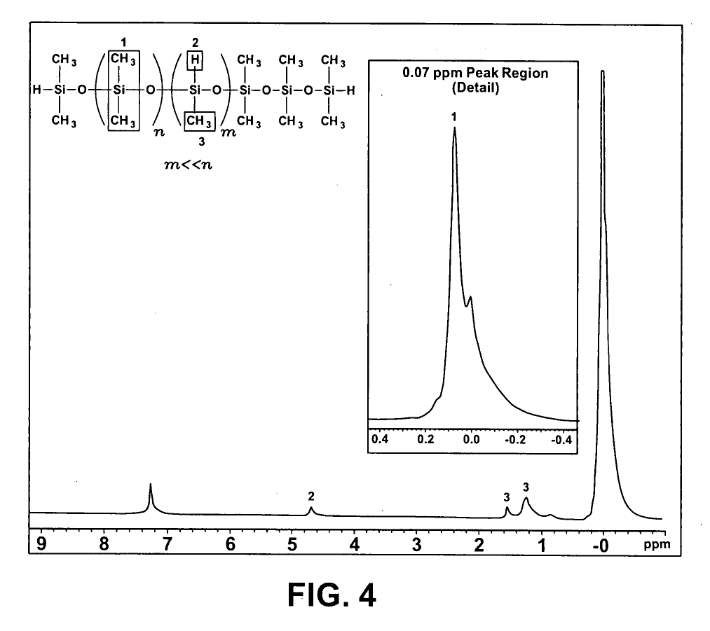

Analysis of the reaction products by ¹H NMR (FIG. 4) shows a strong, characteristic, Si-Me peak at about 0.07 ppm and a Si—H peak at about 4.68 ppm. The peak at about 0.07 ppm generally splits due to an adjacent Me-Si—H atom. Two smaller peaks are observed at about 1.22 and about 1.57 ppm, which result from magnetic inequalities arising from the different stereoconfigurations of the substituents along the polymer backbone. The magnetic nonequivalence of the CH₃ protons results from the fact that one methyl group has two other methyl groups as neighbors in the cis-cis position, whereas the others are surrounded by one methyl and one hydrogen in a cis-trans position.

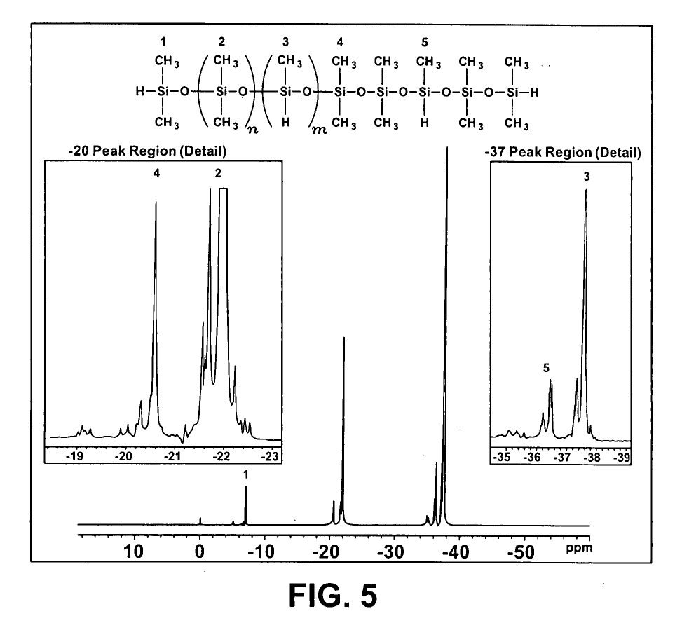

A silicon NMR (J=200) of compound 1 (FIG. 5) shows two primary groups of signals corresponding to the D and D′ (Me-Si—H) units in the difunctional siloxy unit region. In general, a copolymer having a 1:1 molar ratio, and/or having random units, has more symmetric peak patterns. However, when the molar ratio is no longer 1:1 (e.g., 14:1 in this case) and/or the copolymer comprises a block-like microstructure the intensities in the NMR patterns can become asymmetric. Furthermore, the observance of a quartet can result from non-additive chemical shifts resulting from different arrangements of the neighboring units.

The small downfield peak at about −8 ppm is representative of a hydrogen substituted ‘M’ (R₃SiO) unit. Trimethyl substituted M units appear in the 5 to 10 ppm region of the spectrum, which is further evidence that the polysiloxane chain is hydrogen terminated. The downfield shift of the M unit occurs due to the lack of an oxygen atom, which deshields the Si nuclei.

In contrast, D unit silicon atoms comprise R₂SiO. The cluster of peaks near about −21 ppm are representative of various D units. The inset shows peaks between about −20 and about −21 ppm, which are representative of D units that are adjacent to a D′ unit. The non-equivalence of the of the silicon atoms causes a slight downfield shift. The peaks at about −22 ppm symbolize repeating D units in a linear chain. The various peaks are a result of the different molecular weight chains in the sample. The upfield peaks at about −38 ppm are the D′ units within the polysiloxane chain and the same trend with the D units is observed with the D′ units; with the repeating units being slightly upfield of the different adjacent silicon atom peaks. In addition, the starting material 1,3,5,7-tetramethylcyclotetrasiloxane has reacted completely due to the fact that it would appear near −32 ppm in the spectrum.

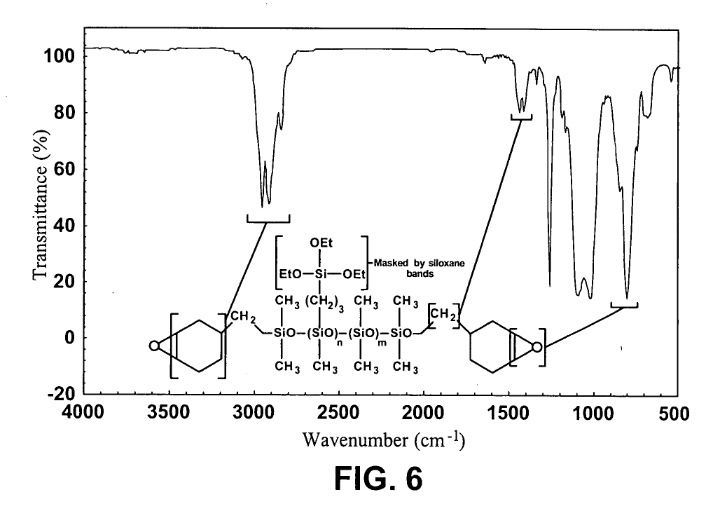

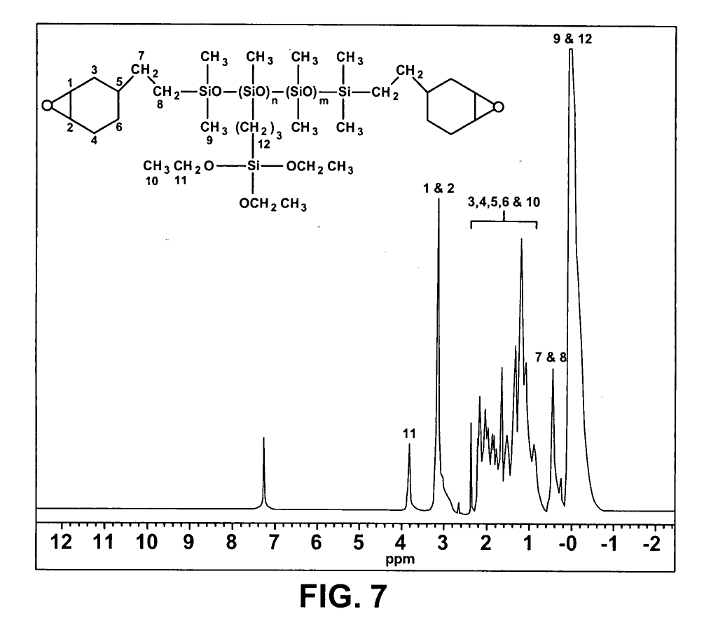

Functionalization of compound 1 with cycloaliphatic epoxides and alkoxy silanes can be evaluated by FT-IR (see FIG. 6), which shows clear evidence of the epoxy ring. However, the Si—O—Si bands at 1000 cm⁻¹ take precedence and mask the alkoxy silane functionality. As a result, proton NMR can be used to confirm that the alkoxy silane group is present (FIG. 7). The triplet at about 3.8 ppm represents the —CH2-protons of the alkoxy silane group.

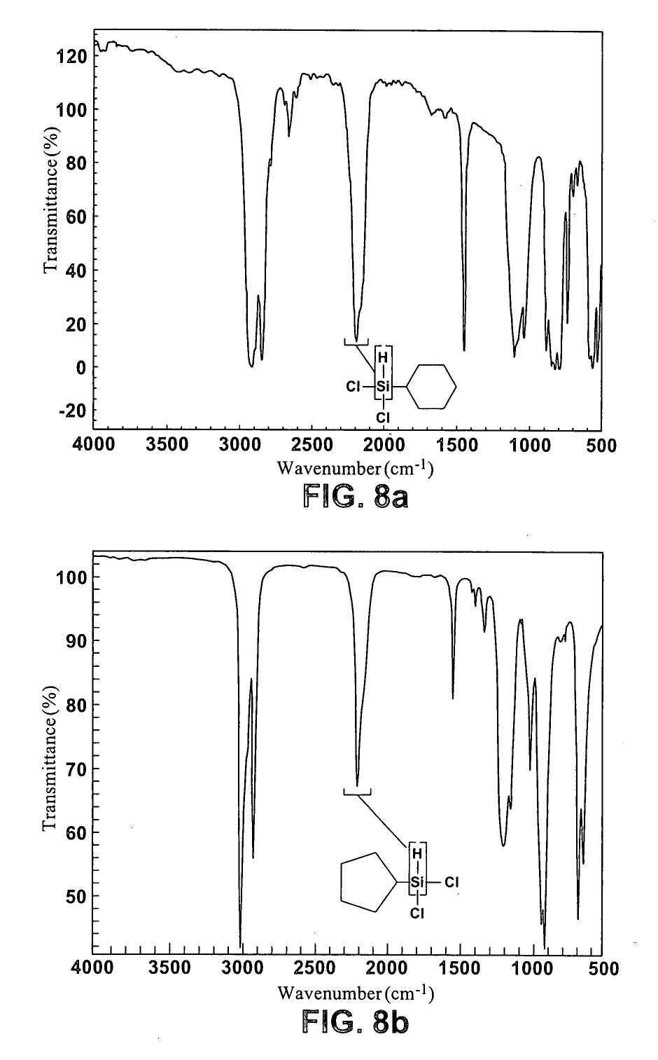

The synthesis of the cycloaliphatic dichlorosilanes can be analyzed by FT-IR, proton NMR, and silicon NMR. The FT-IR spectra of cycloaliphatic dichlorosilanes (FIG. 8) indicate the presence of Si—H (e.g., peak at about 2200 cm⁻¹) and the existence of the Si—Cl₂ functionality at about 500 cm⁻¹. The Si—H transmission peak location can be a good indication of the inductive effects of the other substituents on the silicon atom.

The silane peak position can be predicted to a reasonable degree of accuracy if all of the substituents are known. By adding the wavelength values for each of the substituents (—Cl, —Cl, and —C₅H₉/C₆H₁₁) the location the Si—H peak can be found (see Table 1).

TABLE 1
Calculated and Actual Values of Si—H Transmittance Peaks

| Structure | Calculated (cm⁻¹) | Actual (cm⁻¹) |
|---|---|---|
| Cyclopentyldichlorosilane | 2206 | 2202 |
| Cyclohexyldichlorosilane | 2197 | 2200 |

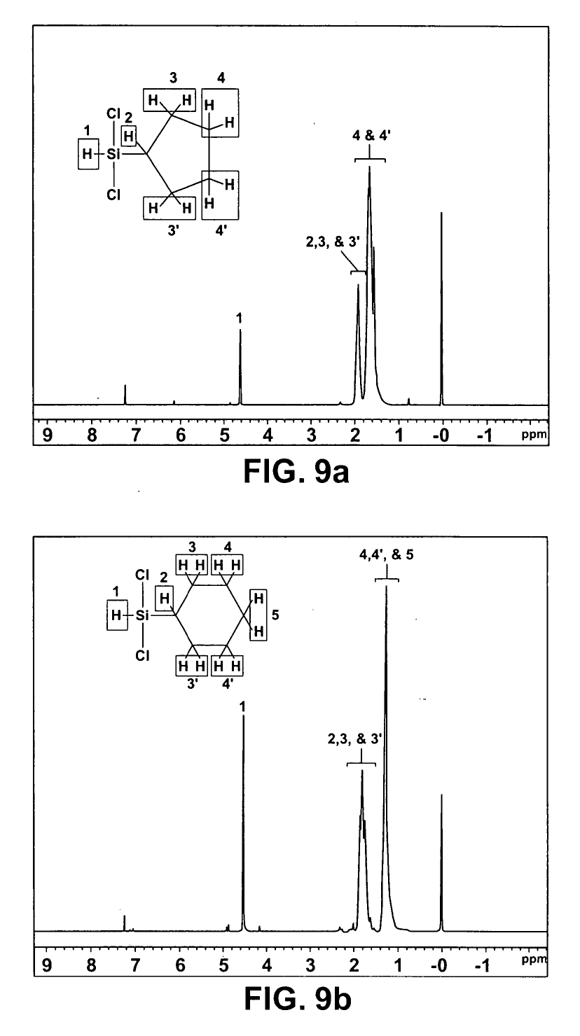

Generally, the proton NMR spectra of the cycloaliphatic dichlorosilanes (e.g., FIG. 9) display at least three distinctive peaks. The upfield peaks are representative of the cycloaliphatic substituent(s), while the downfield peak(s) indicates a Si—H proton. The Si-alkyl groups usually display the expected shift patterns representative of the substituent due to the shielding effects of the silicon atom. However, such patterns can be affected by the inductive and/or shielding effects of the other substituents on the silicon atom. Closer examination of the Si—H peak reveals a multiplet, which could be the result of the sample reacting with residual water left in the CDCl₃ and producing oligomers of three to six units long. The presence of the small pair of satellite lines near the main resonance of the Si—H peak is a result of the ²⁹Si isotope. The location of the Si—H peaks between the cyclopentyl and cyclohexyl group differ by approximately 0.1 ppm, but show that only subtle changes in the substituents can affect the position of the Si—H peak.

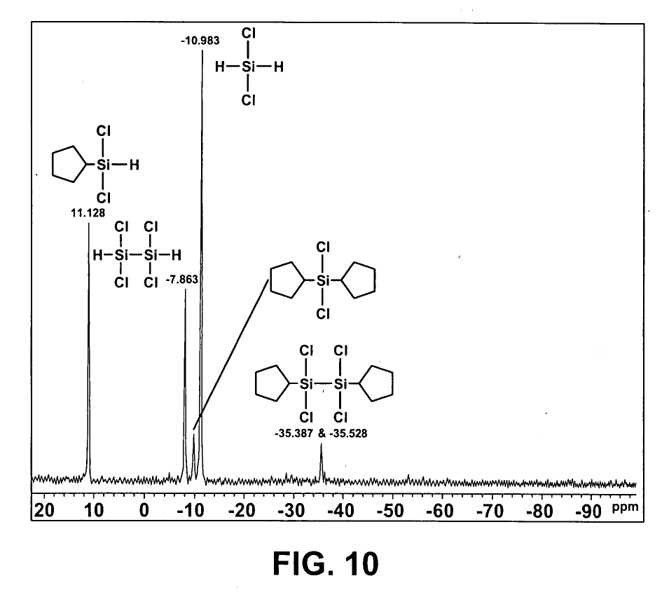

Silicon NMR can also be used to analyze the reaction product (see FIG. 10). FIG. 10 shows that several side products are formed in addition to the desired product. The formation of the disilane compounds (e.g., tetrachlorodisilane and dicyclopentyltertrachlorosilane) is of particular interest in that the catalyst used is not only selective towards hydrosilation through alkenes, but also can undergo addition reactions to form disilane compounds. Bulky substituents tend to hinder the formation of disilane compounds, while the smaller groups yield more.

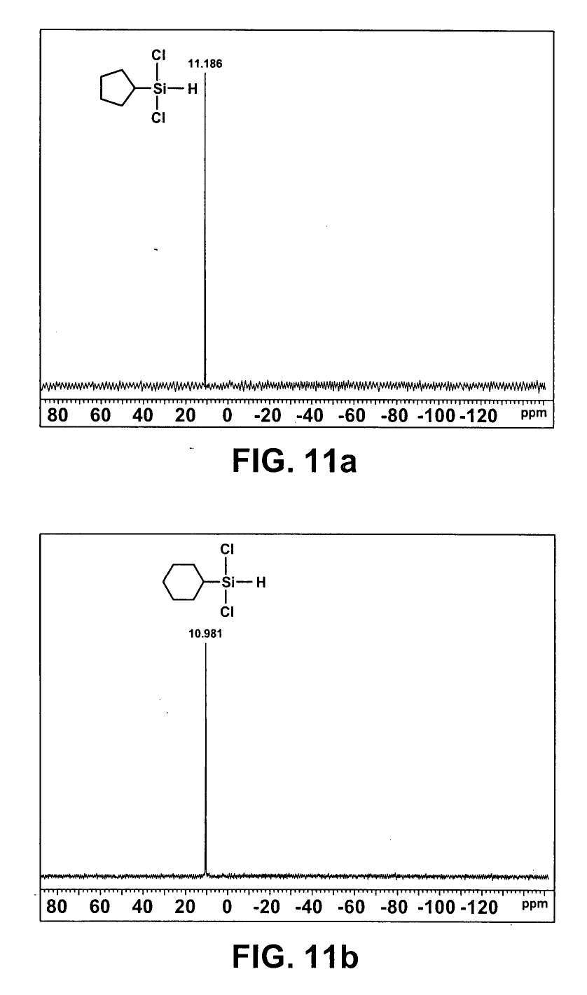

Following distillation, silicon NMR (e.g., see FIG. 11) indicates the presence of the desired cycloaliphatic substituted silane. The difference between the cyclohexyl and cyclopentyl peaks is only about 0.205 ppm. This indicates that the cyclopentyl, having one less carbon atom, has enough ‘deshielding’ character to cause an upfield shift in the peak signal.

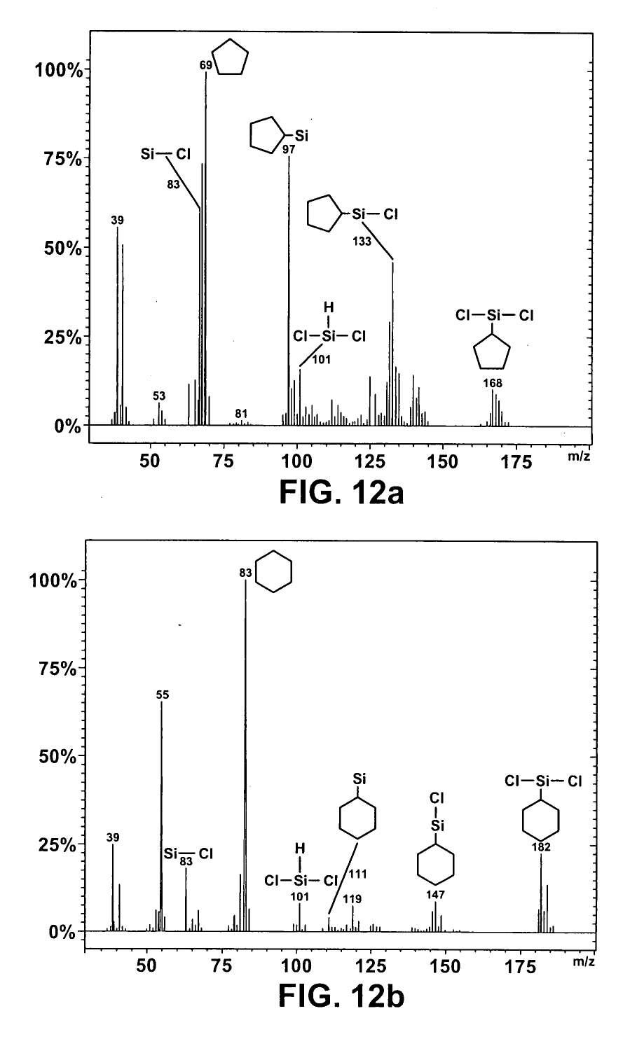

The mechanistic fragmentation of R₄Si compounds, where R varies independently among alkyl, aryl, hydride, or the like can be studied. FIG. 12 shows mass spectra for both cyclopentyldichlorosilane and cyclohexyldichlorosilane. Furthermore, this figure shows the radical cleavage of each of the four R groups. Generally, the cyclohexyl R groups tend to cleave faster than cyclopentyl. Furthermore, in compounds having R groups similar to those set forth here (e.g., cyclic hydrocarbons, and lower alkyls), there is an added tendency to lose an HCl group, thereby leaving an ion having an odd electron. FIG. 12 includes evidence of an HCl loss (m/z 133 for cyclopentyldichlorosilane) and (m/z 147 for cyclohexyldichlorosilane). The presence of the molecular ion, predictable radical cleavages, and recognizable isotopic peak patterns makes mass spectral interpretation of this class of compounds relatively straightforward.

The acid-liberating polymerization of dichlorosilanes is an equilibrium process; the reverse reaction may seriously affect the molecular weight and overall linearity of the polymerized product unless the acid is neutralized from the system. The substituents are usually resistant towards the HCl that is given off as a bi-product, such as dichlorodimethylsilane. However, if a Si—H group is present the HCl released will react with it according to the reaction below:
Si—H+HCl→Si—Cl+H₂ (4)
and form an undesired Si—Cl, which can undergo hydrolysis and rather than a linear polysiloxane chain a substituted silsesquioxane is formed. Therefore, a saturated aqueous basic solution is used to neutralize the liberated acid.

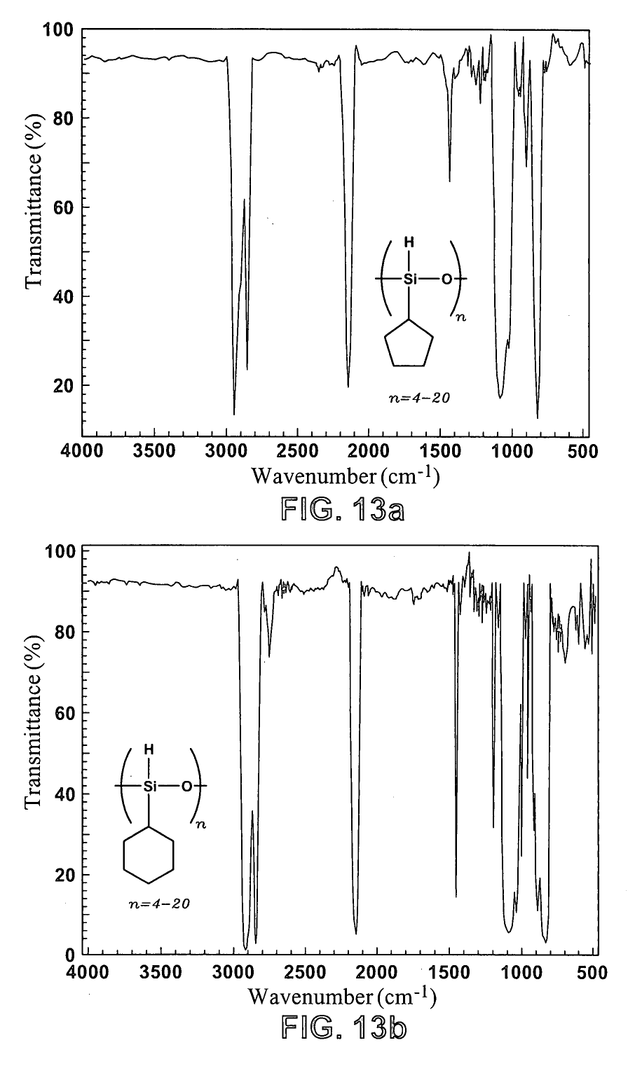

The hydrolytic polymerization reaction products can be analyzed by FT-IR (e.g., see FIG. 13). The strength of the Si—O—Si band indicates that the rings are not of sufficient size (e.g., less than about 20 units). Additionally, the absence of the characteristic antisymmetric Si—O—Si stretch at about 1100 cm⁻¹ also suggests rings under 20 units (compare to FIG. 8). Furthermore, the disappearance of the Cl—Si—Cl peaks around the 500 cm⁻¹ region indicates that a majority of the material reacts thereby forming polysiloxane chains. Still further, the absence of a Si—OH peak, which is typically found near the 3700 cm⁻¹ region is evidence that cyclic species are present, and that no linear chains terminating with a Si—OH are produced. Finally, the Si—H peak is present, which indicates that the HCl byproduct is effectively neutralized.

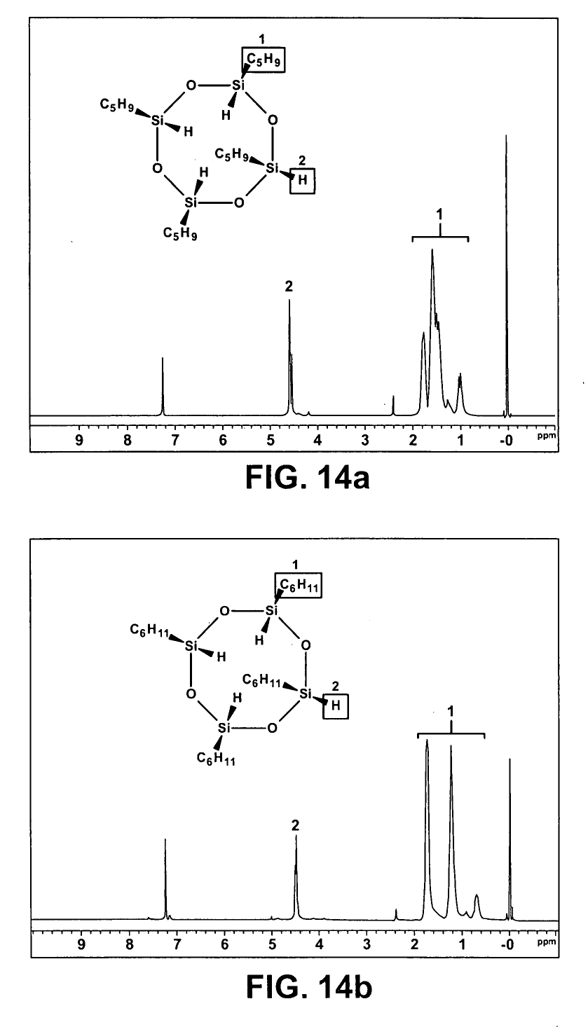

Proton NMR spectra of the cyclic oligomers show trends similar to that of compound 1 (c.f., FIGS. 14 and 4). Since the substituents along the polysiloxane chains are atactic, their magnetic environments are different, which causes the protons to produce distinct NMR signals. When the spectra of FIG. 14 are compared to those of FIG. 9 it is apparent that the cis/trans configurations affect the NMR spectra. With reference to the Si—H proton peak at about 4.5 ppm, splitting is evident. This is also due to the atactic configurations of the substituents. For instance, a hydrogen atom can be surrounded by two hydrogens, one hydrogen and one cycloaliphatic ring, or two cycloaliphatic rings. Similarly, atacticity also affects cycloaliphatic protons to a lesser degree.

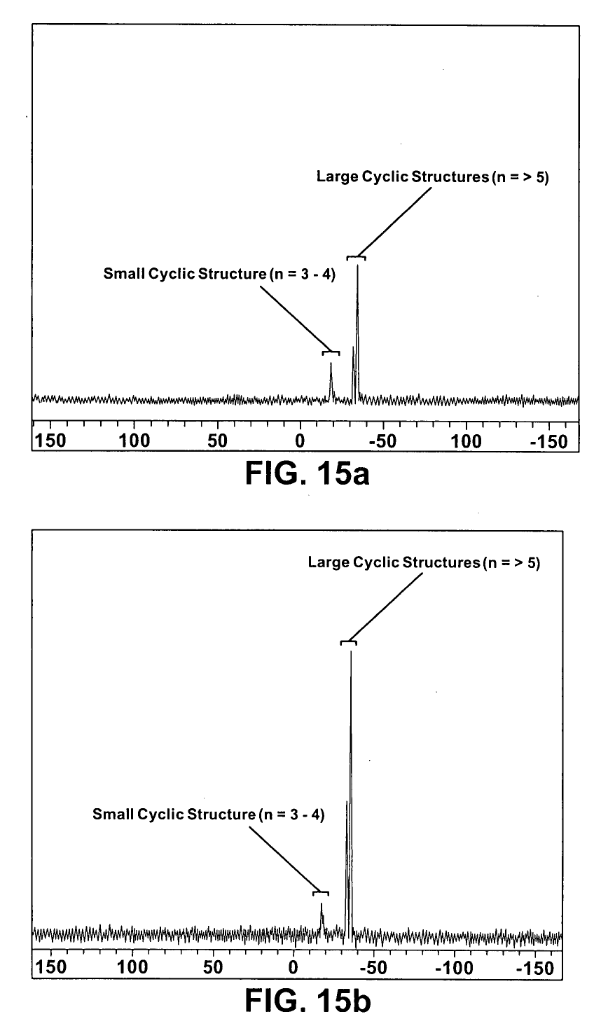

Silicon NMR (J=200) of the foregoing oligomers (FIG. 15) displays evidence of cyclic species. The downfield peaks represent low molecular weight oligomers comprising cyclic D units. Generally, the upfield peaks are characteristic of larger cyclic D units. The peaks at about −30 ppm are indicative of D units having the general formula (R—Si—O₂—H)_{n>5}, while the peaks near −20 ppm represent smaller cyclic siloxane structures having the general formula (R—Si—O₂—H)_{n=3 or n=4}. In small-ring embodiments (e.g., n=3 or n=4), ring strain tends to deshields the ²⁹Si nucleus resulting in shifts to higher frequencies. A plurality of peaks results from a variety of distinct magnetic microenvironments present along the oligomer chain, and the variously sized cyclic structures. FIG. 15 shows that no Si—OH or Si—Cl groups are detectable, which are the possible end groups of linear chains. Accordingly, this data indicates that the predominant products comprise cyclic siloxanes, and that linear products are at least below detectable levels or absent altogether.

The data indicates that in some embodiments the average size of the cyclic structures is 15 units. In these embodiments, the cyclic chains' small size could be a result of diluted cycloaliphatic dichlorosilane precursors. Additionally, this could be the result of the dropwise method of adding silanes into the organic phase. Significantly, some embodiments of both the cyclopentyl and cyclohexyl oligomerization reactions produce approximately 10% small cyclic species having about three to four siloxane units. In some embodiments it is expected that molecular weights as high as about 4000 g/mol can be measured by GPC, which indicates a ring size of about 37 siloxane units.

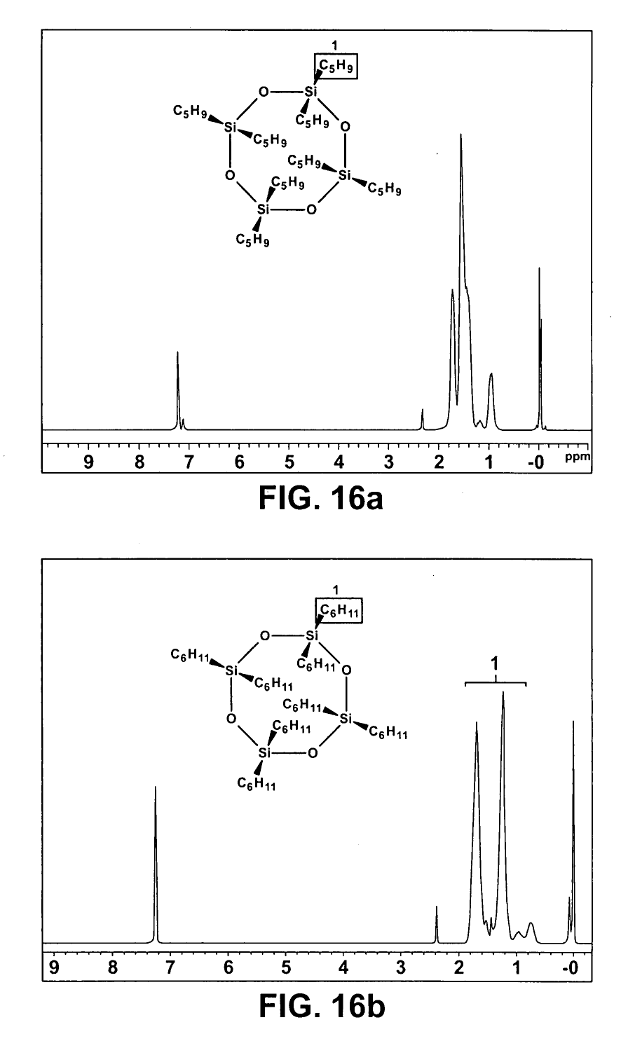

According to proton NMR hydrosilating compounds 2 and 3 with a cycloalkene produces the corresponding cyclic oligomers of polydicycloaliphaticsiloxane (see FIG. 16). FIG. 16 shows the disappearance of the Si—H functionality (about 4.5 ppm), and shows strong cycloaliphatic character. The disappearance of the Si—H group is also verified by FT-IR. In some embodiments, the reaction is sluggish due to the bulky substituents, and because the alkene functionality undergoing hydrosilation is an internal alkene (e.g., allylic) as opposed to the faster reacting terminal alkene (i.e., vinylic). The cyclic structure of the polysiloxanes also plays a role in the rate of hydrosilation.

In some embodiments the cyclic oligomers of the polydicycloaliphaticsiloxanes can be combined with that of the polycycloaliphatichydrosiloxanes to yield poly(dicycloaliphaticsiloxane-co-cycloaliphatichydrosiloxane), hydride terminated (e.g., compounds 2 and 3). In one embodiment the procedure for preparing compounds 2 and 3 is analogous to that of compound 1 in that it uses an A-15 ion exchange resin, and an end capper for controlling molecular weight. Without the end capper the chains terminate predominantly by chance, which extends the lifetime of the reaction. In one embodiment, a % Si—H analysis of compounds 2 and 3 yields 11.5±1.1% Si—H and 10.8±0.9% Si—H. In some embodiments GPC indicates that both compounds 2 and 3 have molecular weights of about 35,000 g/mol.

In some embodiments photo differential scanning calorimetry (PDSC) can be used to study the relationship between polymer structure and reaction conditions. Particularly, some embodiments include photo-initiated cationic polymerization of functionalized polysiloxanes, which may yield highly crosslinked networks. Reaction rate can be measured by observing the rate at which heat is released from a polymerizing sample. In general, cationic polymerization kinetics varies from system to system and are often complex. While not wishing to be bound by any one theory, in many embodiments this variation and complexity is believed related to the dependency of the carbocationic center's reactivity on its proximity to a counterion. Additionally, in some embodiments a number of propagating species can be identified during polymerization such as ion pairs, solvated ions, and/or aggregates. Thus, a general kinetic equation is not available.

In some embodiments the pseudo steady-state approximation is invalid because the active centers do not undergo combination, as seen in free radical polymerizations. Consequently, in such embodiments the rates of initiation and termination are not equal, which renders the pseudo steady-state approximation inadequate to describe these reaction kinetics.

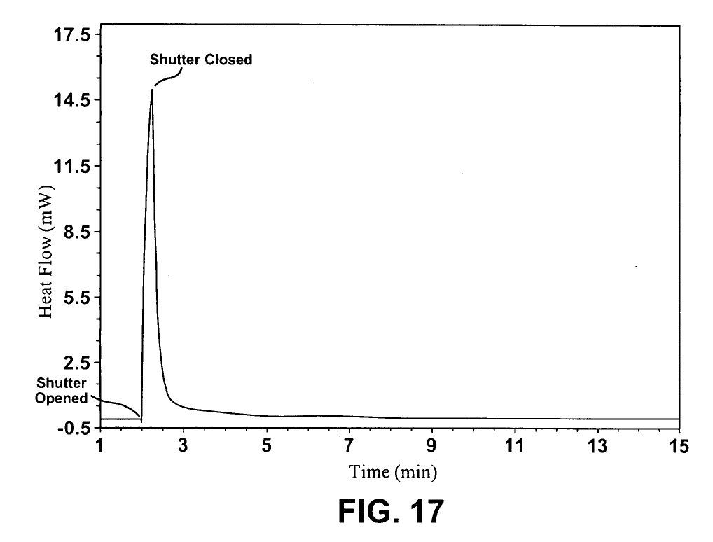

PDSC reaction runs can be carried out at various temperatures (e.g., −10° C., 25° C., and 60° C.) in studies directed to establishing an overall activation energy for a polymerization. Additionally, the relationship between exposure time and reaction rate can be determined by collecting data under various exposure time conditions (e.g., 1, 5, and 15 seconds). FIG. 17 shows a typical exotherm that can be obtained from photo-induced polymerizations.

The degree of cure, or conversion, can be estimated from the ratio of the amount of heat evolved from the partial conversion after time t at a specific temperature (Hₜ); to the total heat evolved from the reaction, ΔHₚ:
α=(Hₜ/ΔHₚ) (5)
If Equation (5) is a function of conversion, but not temperature, as is the case in photo-induced experiments, the activation energy, E, can be obtained by plotting ln[(1/ΔHₚ)(dH₀/dₜ)] versus (1/T), where (dH₀/dₜ) is the heat of polymerization at the maximum peak of the exotherm. Calculating the slope of this plot yields the activation energy (see Table 2). Photo-DSC experiments record the total heat of polymerization. Therefore, the activation energy is representative of an overall activation energy, which includes initiation, propagation, and termination:
E_{R}=E_{I}+E_{P}−E_{T} (6)

In order for the above equation to be valid, the production of active centers must continue throughout the reaction. In some embodiments adhering to this theory, the photosensitizers are not completely consumed until after the reaction has progressed beyond the peak maximum. Therefore, Equation (6) can be used to determine the overall activation energy for the photo-induced polymerization reaction.

According to some embodiments, the reaction rate and total conversion increases with increasing temperature. In such embodiments, this can be determined by obtaining exotherms exhibiting a larger integrated heat as temperature increases.

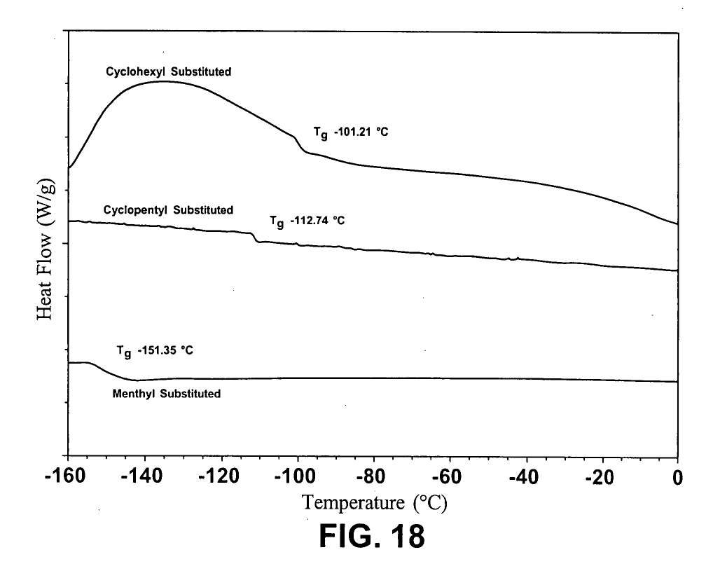

In some embodiments increasing the size of the substituent has a notable effect on the rate of polymerization and total conversion (see Table 2). FIG. 18 also shows that as the glass transition temperature (T_{g}) increases with increasing size of the pendant group. In some embodiments, the rates of polymerization decrease by an overall average of about 50% in comparison of a methyl substituted to a cycloaliphatic substituted polysiloxane. While not wishing to be bound to any one theory, it is believed that in such embodiments this can be attributed to the large bulky substituents hindering molecular motion, and thereby preventing the active species from further polymerization.

In general, longer exposures to UV light results in a higher conversion due to the production of more active species. FIG. 18 illustrates that the glass transition temperature can be tailored by changing one or more pendant groups. Appropriate pendant groups can be chosen from any of a variety of alkene functionalized moieties.

TABLE 2
Effect of Substituent and Temperature on the Rate of Polymerization

| | | Exposure | Heat Flow | | | Activation |
|---|---|---|---|---|---|---|
| | | Time | per Second | | | Energy |
| Substituent | Temperature(C. °) | (sec) | (J/s) | Rₚ (/s) | Conversion % | (kJ/mol) |
| Methyl | −10 | 5 | 9.456 | 0.0093 | 99.6 | |
| | 25 | 5 | 14.900 | 0.0110 | 99.5 | 144.8 ± 8.1 |
| | 60 | 5 | 19.646 | 0.0125 | 99.7 | |
| Cyclopentyl | −10 | 5 | 8.223 | 0.0025 | 90.4 | |
| | 25 | 5 | 5.892 | 0.0055 | 97.2 | 111.0 ± 9.2 |
| | 60 | 5 | 11.723 | 0.0057 | 97.4 | |
| Cyclohexyl | −10 | 5 | 8.113 | 0.0054 | 91.2 | |
| | 25 | 5 | 5.932 | 0.0047 | 96.7 | 125.7 ± 8.5 |
| | 60 | 5 | 16.890 | 0.0068 | 98.2 | |

Synthesis of poly(dimethylsiloxane-co-methylhydrosiloxane), hydride terminated (compound 1). The synthesis diagram set forth in FIG. 1, is a schematic representation of the following process. The following components are added to a three neck round bottom flask equipped with a reflux condenser and nitrogen inlet/outlet ports. Octamethylcyclotetrasiloxane (90.00 g, 0.30 mol), 1,3,5,7-tetramethyl-cyclotetrasiloxane (5.33 g, 22.1 mmol), 1,1,3,3-tetramethyidisiloxane (0.67 g, 5.3 mmol), and Amberlyst 15 (20 wt %). These components are stirred for 15 hours at 70° C. under nitrogen. The viscous solution is then filtered thereby obtaining poly(dimethylsiloxane-co-methylhydrosiloxane), hydride terminated (i.e., compound 1). As filtered, the preparation contains a variety of molecular weights. Vacuum filtration is performed at less than about 1 mm Hg, which serves to remove low molecular weight oligomers and unreacted starting materials. The weight-average molecular weight (M_{w}) can be obtained from gel-permeation chromatography (GPC) analysis, and is about 42,000 with a polydispersity index of about 1.66. The product can be characterized, and the Si—H functionality confirmed, by ²⁹Si NMR, ¹H NMR, FT-IR analysis, and/or titrations (e.g., the foregoing mercury titration). Polysiloxanes 2 and 3 can be produced in a similar manner.

Synthesis of cycloaliphatic dichlorosilane (see FIG. 2): The hydrosilation between dichlorosilane and the cycloalkene is performed in a manner designed to control the amount of silane functionality along the polysiloxane backbone. The reaction of the mono- and disubstituted cycloaliphatic substituted cyclic oligomers is similar to that of the methyl substituted polysiloxane (c.f., FIGS. 1 and 2). The control over the ratio of mono- and disubstituted cyclic oligomers enables management of the silane functionality present along the polymer backbone. In some embodiments, mono- and di-substituted cyclic oligomer ratios are 1:18.

Some embodiments include preparation of cycloaliphatic dichlorosilane. One example of such a preparation includes the following. A stainless steel bomb reactor is dried, sealed, evacuated, and cooled in a dry ice/acetone bath to about −80° C. The reactor is charged with chilled cycloalkene (e.g., about 5 g, or 30 mmol) and Wilkinson's catalyst (e.g., about 0.15 g or 0.16 mmol) and purged with nitrogen. Dichlorosilane (e.g., about 5 mL or 0.06 mol) is added to a calibrated tube and chilled to less than about −10° C. The dichlorosilane is condensed and then distilled into the bomb via a cannula in fluid communication with the bomb's inlet valve. Then the inlet valve is sealed and the bomb is allowed to warm to room temperature. The bomb is then heated for 24 hours at 120° C. by means of an oil bath. The bomb is allowed to cool before collecting the product. The reaction produces a clear, light yellow liquid, which can be distilled. After distillation, any residual unreacted cycloalkene and/or side products are removed under vacuum (e.g., at about 2 to 3 mmHg) to yield pure cycloaliphatic dichlorosilane (e.g., about 88% yield). The product can be characterized by ²⁹Si NMR, ¹H NMR, FT-IR, and/or mass spectroscopy.

General synthesis of cyclic oligomers of polycycloaliphatic-hydrosiloxane: Some embodiments include synthesis of one or more polycycloaliphatichydrosiloxanes. One example of such a synthesis includes the following. A saturated aqueous sodium bicarbonate (10 mL) and diethyl ether (5 mL) are added to a three-neck round bottom flask, equipped with a reflux condenser, nitrogen inlet/outlet ports, and a dropping funnel. A solution of cycloaliphatic dichlorosilane (e.g., about 4.43 g, or 0.03 mol) in ethyl ether (about 5 mL) is then added dropwise through the dropping funnel and the solution is stirred for several minutes at room temperature. The ether layer is separated, passed through a filter, and any remaining traces of ether are removed through vacuum distillation at about 3 to 5 mm Hg thereby yielding a clear, viscous oil. Weight average molecular weights (M_{w}) can be obtained for both the cyclopentyl and cyclohexyl substituted cyclic oligomers by gel permeation chromatography (GPC). Polycyclopentylhydrosiloxane oligomers prepared according to this example have a M_{w} of about 1,800 and a PDI of about 2.44. Additionally, polycyclohexylhydrosiloxane oligomers prepared according to this example have a M_{w} of about 2,230 and a PDI of about 2.53. The oligomers can be characterized by ²⁹Si NMR, ¹H NMR, FT-IR, and/or mass spectroscopy.

Synthesis of cyclic oliqomers of polydicycloaliphaticsiloxane: Some embodiments include synthesis of one or more polydicycloaliphaticsiloxanes. One example of such a synthesis includes the following. A single neck round bottom flask is equipped with a reflux condenser. The following components are added to the flask: cyclic oligomers of the desired polycycloaliphatichydrosiloxane (e.g., about 5 g), a cycloalkene (e.g., about 15 g), and Karstedt's catalyst (e.g., about 0.1 mL or 0.22 mmol). The reaction is held at 110° C. in an oil bath and magnetically stirred. The disappearance of the Si—H functionality is monitored through FT-IR and the disappearance of the peak at about 2160 cm⁻¹ indicates that the reaction is complete. Generally, the reaction is substantially complete after about 48 hours. Any unreacted cycloalkenes can be removed under a vacuum of about 3 to 1 mm Hg thereby yielding a clear, viscous oil. The product(s) can be characterized by ²⁹Si NMR, ¹H NMR, FT-IR, and/or mass spectroscopy.

Cycloaliphatic epoxide and alkoxy silane functionalization of prepared poly(dialkyllsiloxane-co-alkylhydrosiloxane), hydride terminated polymers. Some embodiments include synthesis of one or more poly(dialkyllsiloxane-co-alkylhydrosiloxane). One example of such a synthesis includes the following. A three neck round bottom flask is equipped with a reflux condenser and nitrogen inlet/outlet ports. Next, the following components are added to the flask—compounds 1, 2, or 3 (e.g., about 30 g), 4-vinyl-1-cyclohexene diepoxide (e.g., about 20 g or 0.18 mol), vinyl triethoxysilane (e.g., about 2 g or 0.01 mol), and Wilkinson's catalyst (e.g., about 0.004 g or 4.3 μmol). Then, dry, distilled toluene (e.g., about 30 g) is added via a cannula. The reaction is then held at 75° C. in an oil bath and mechanically stirred under nitrogen. The disappearance of the Si—H functionality is monitored through FT-IR and the disappearance of the peak at about 2160 cm⁻¹ indicates that the reaction is complete. Any solvent and/or unreacted starting materials are removed under a vacuum of about 3 to 5 mm Hg. Cycloaliphatic epoxide and alkoxy silane functionalization can be confirmed by ¹H NMR, FT-IR, and/or titration.

The present invention provides, among other things, a variety of new material choices for applications such as membranes, films, aerospace materials, paints, and protective coatings. Furthermore, the present invention provides the capacity to tailor the siloxane polymer's pendant groups, which can be used to resolve miscibility and grafting issues by using groups similar in structure and/or polarity to a solvent. Additionally, some embodiments of the present invention can be used in connection with cycloaliphatic epoxides, alkoxy silane groups, and/or UV curable hybrid films to make membranes and/or or low coefficient of friction coatings. Still further, some embodiments provide the ability to adjust the glass transition temperature by varying the siloxane's pendant groups. Thus, some embodiments include lubricants for fibers, wetting agents for polyurethane foams, and temperature sensitive coagulating agents for latexes.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What is claimed is:

1. A process for preparing substituted siloxane polymers comprising the steps of:
(A) providing at least one first cyclic siloxane according to the general structure shown below: 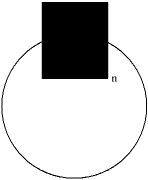
wherein R₁ and R₂ are selected independently from methyl, ethyl, propyl, butyl, cyclopentyl, and cyclohexyl and wherein n is an integer from 3 to 50;
(B) providing at least one second cyclic siloxane according to the general structure shown below: 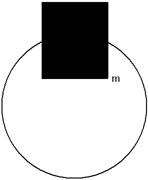
wherein R₃ and R₄ are selected independently from hydride, methyl, ethyl, propyl, butyl, cyclopentyl, and cyclohexyl, and wherein at least a portion of R₃ comprises hydride, and wherein m is an integer from 3 to 50;
(C) providing at least one disiloxane according to the general structure shown below: 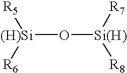
wherein R₅, R₆, R₇, and R₈ are independently selected from hydride, methyl, ethyl, propyl, butyl, cyclopentyl, and cyclohexyl;
(D) combining the at least one first cyclic siloxane, the at least one second cyclic siloxane, and the at least one disiloxane with an effective amount of ion exchange resin at a temperature from about −20° C. to about 80° C., for a time sufficient to result in condensation of at least a portion of the first and second cyclic siloxane and disiloxane; and
(E) recovering at least one siloxane product.

2. The process of claim 1, wherein R₁ and R₂ comprise methyl groups.

3. The process of claim 1, wherein R₃ and R₄ are selected independently from hydride and methyl, and wherein at least a portion of R₄ comprises hydride.

4. The process of claim 1, wherein R₅, R₆, R₇, and R₈ are methyl groups.

5. The process of claim 1, wherein n is an integer from 3 to 8.

6. The process of claim 1, wherein m is an integer from 3 to 8.

7. The process of claim 1, further comprising the step of catalytically reacting the at least one siloxane product with an effective amount of at least one cycloaliphaticepoxide having at least one vinylic reactive center; and collecting at least one polysiloxane product having cycloaliphatic epoxide end-caps.

8. A process for preparing substituted siloxane polymers comprising the steps of:
(a) providing at least one first cycloalkene and at least one dichlorosilane;
(b) reacting the at least one first cycloalkene with the at least one dichlorosilane thereby forming at least one cycloaliphatic dichlorosilane having a general formula according to the structure below: 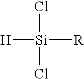
wherein R is selected from cyclopentyl and cyclohexyl;
(c) polymerizing the at least one cycloaliphatic dichlorosilane thereby forming at least one cyclic oligomer of polycylcoaliphatichydrosiloxane having a general formula according to the structure below: 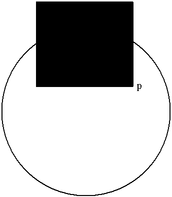
wherein p is an integer from 3 to 50;
(d) reacting a first portion of the at least one cyclic oligomer of polycylcoaliphatichydrosiloxane from Step (c) with at least one second cycloalkene thereby forming at least one cyclic oligomer of polydicycloaliphaticsiloxane having a general formula according to the structure below: 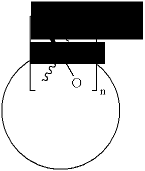
wherein the reaction is carried out in the presence of an effective amount of at least one catalyst, and wherein R₁ and R₂ are independently selected from cyclopentyl and cyclohexyl;
(e) reacting a second portion of the at least one cyclic oligomer of polycylcoaliphatichydrosiloxane from Step (c) with the at least one cyclic oligomer of polydicycloaliphaticsiloxane from Step (d) thereby forming at least one copolymer thereof; and
(f) recovering the at least one copolymer from Step (e).

9. The process of claim 8, wherein the process for preparing the at least one polycylcoaliphatichydrosiloxane further comprises the steps of:
charging a bomb reactor with an effective amount of at least one first cycloalkene and an appropriate catalyst;
distilling dichlorosilane and collecting the distillate directly in the bomb reactor under inert conditions;
heating the bomb reactor to about 120° C. for about 24 hours; and
collecting and purifying at least one substituted dichlorosilane reaction product.

10. The process of claim 8, wherein the process for preparing the at least one cyclic oligomer of polycylcoaliphatichydrosiloxane further comprises the steps of:
adding an effective amount of the cycloaliphatic dichlorosilane to a solution of aqueous sodium bicarbonate and ether;
allowing at least a portion of the at least one cycloaliphatic dichlorosilane to polymerize; and
collecting the at least one cyclic oligomer of polycylcoaliphatic-hydrosiloxane.

11. The process of claim 8, wherein the process for preparing the at least one cyclic oligomers of polydicycloaliphaticsiloxane further comprises the steps of:
reacting an effective amount of at least one cyclic oligomer of polycylcoaliphatichydrosiloxane with an effective amount of at least one second cycloalkene, wherein the reaction is carried out in the presence of an effective amount of at least one catalyst, and wherein the reaction is carried out at about 110° C. for about 48 hours; and
collecting and purifying the at least one cyclic oligomers of polydicyclo-aliphaticsiloxane.

12. The process of claim 8, wherein the process for preparing the copolymer further comprises the steps of:
combining effective amounts of the at least one cyclic oligomer of polycylcoaliphatichydrosiloxane and the at least one cyclic oligomers of polydicycloaliphaticsiloxane, with an effective amount of an appropriate ion exchange resin under conditions supporting polycondensation of the cyclic oligomers;
allowing sufficient time for the polycondensation reaction to proceed at least partially toward completion; and
collecting and purifying the copolymer product.

13. A process for preparing substituted siloxane polymers comprising the steps of:
(i) providing at least one first cyclic siloxane according to the general structure shown below: 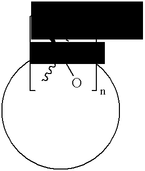
wherein R₁ and R₂ are methyl and wherein n is an integer from 3 to 50;
(ii) providing at least one second cyclic siloxane according to the general structure shown below: 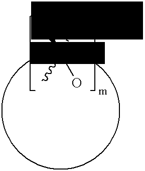
wherein R₃ and R₄ are selected independently from hydride and methyl, wherein at least a portion of R₃ and R₄ comprise hydride, and wherein m is an integer from 3 to 50;
(iii) providing at least one disiloxane according to the general structure shown below: 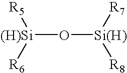
wherein R₅, R₆, R₇, and R₈ are independently selected from hydride, methyl, ethyl, propyl, butyl, cyclopentyl, and cyclohexyl;
(iv) combining the at least one first cyclic siloxane, the at least one second cyclic siloxane, and the at least one disiloxane with an effective amount of ion exchange resin at a temperature from about −20° C. to about 80° C., for a time sufficient to result in condensation of at least a portion of the first and second cyclic siloxane and disiloxane; and
(v) recovering at least one siloxane product.

14. The process of claim 13, wherein R₅, R₆, R₇, and R₈ are methyl groups.

15. The process of claim 13, wherein n is an integer from 3 to 8.

16. The process of claim 13, wherein m is an integer from 3 to 8.

17. The process of claim 13, further comprising the step of catalytically reacting the at least one siloxane product with an effective amount of at least one cycloaliphaticepoxide having at least one vinylic reactive center; and collecting at least one polysiloxane product having cycloaliphatic epoxide end-caps.
